(19) United States
(12) Patent Application Publication
(10) Pub. No.: US 2020/0275439 A1
(43) Pub. Date: Aug. 27, 2020

(54) SLOT FORMAT INDICATION METHOD, DEVICE, AND SYSTEM

(71) Applicant: HUAWEI TECHNOLOGIES CO., LTD., SHENZHEN, GUANGDONG (CN)

(72) Inventors: Yifan XUE, Beijing (CN); Da WANG, Shenzhen (CN); Jian WANG, Beijing (CN); Yun LIU, Shenzhen (CN)

(21) Appl. No.: 16/642,349

(22) PCT Filed: May 16, 2018
(86) PCT No.: PCT/CN2018/087106

§ 371 Date: Feb. 26, 2020

(30) Foreign Application Priority Data
Sep. 8, 2017 (CN) 201710808019.2

(51) Int. Cl. H04W 72/04; H04L 1/00; H04L 5/00

(52) U.S. Cl. CPC H04W 72/0446; H04L 5/001; H04L 1/0029

(57) ABSTRACT

This application relates to the field of communications technologies, and discloses a slot format indication method, a device, and a system. The method includes: generating, by a network device, first indication information, and sending the first indication information to a terminal device; and after receiving the first indication information, determining, by the terminal device, slot formats of M CCs based on the first indication information. The first indication information indicates K slot formats. The K slot formats are the slot formats of the M CCs configured for the terminal device. At least one slot format in the K slot formats is corresponding to at least two CCs in the M CCs. Configuration parameters of the at least two CCs have at least one type of same parameter. The configuration parameter includes at least one of the following parameters: a subcarrier spacing, a cyclic prefix, a bandwidth, or a frequency band.

### CROSS REFERENCE TO RELATED APPLICATIONS

This application is a National Stage of International Application No. PCT/CN2018/087106, filed on May 16, 2018, which claims priority to Chinese Patent Application No. 201710808019.2, filed Sep. 8, 2017. Both of the aforementioned applications are hereby incorporated by reference in their entireties.

### TECHNICAL FIELD

This application relates to the field of communications technologies, and in particular, to a slot format indication method, a device, and a system.

### BACKGROUND

In Long Term Evolution (LTE), it is stipulated that a component carrier (CC) may have a maximum bandwidth of 20 MHz. However, as communications technologies continuously develop, the 20 MHz bandwidth cannot meet a requirement of a Long Term Evolution Advanced (LTE-A) system for a downlink peak rate of 1 Gbps and an uplink peak rate of 500 Mbps. Therefore, a carrier aggregation (CA) technology is introduced.

Specifically, the CA technology means aggregating two or more CCs to support a larger transmission bandwidth. In the LTE-A system, one terminal device supports a maximum of five CCs. However, in a next-generation wireless communications (NR) system, one terminal device supports a maximum of 16 CCs in each of an uplink direction and a downlink direction.

However, after configuring a plurality of CCs for a terminal device, a base station further needs to indicate slot format information (SFI) of each CC to the terminal device, so that the terminal device can send and receive data on the CC. In the prior art, generally, the base station indicates SFI of a CC to the terminal device in the following manner: When the base station configures a plurality of CCs for the terminal device, the base station adds slot format information (SFI) of each CC into a group common physical downlink control channel (PDCCH) on the CC, and sends the group common physical downlink control channel to the terminal device. Alternatively, the base station adds SFI of the plurality of CCs into a group common PDCCH on one of the plurality of CCs, and sends the group common PDCCH to the terminal device. For example, if the base station configures a CC 1, a CC 2, and a CC 3 for the terminal device, the base station may send SFI of the CC 1 to the terminal device by using a group common PDCCH on the CC 1, send SFI of the CC 2 to the terminal device by using a group common PDCCH on the CC 2, and send SFI of the CC 3 to the terminal device by using a group common PDCCH on the CC 3; or the base station sends SFI of the CC 1, SFI of the CC 2, and SFI of the CC 3 to the terminal device by using a group common PDCCH on one of the CC 1, the CC 2, and the CC 3. In the foregoing manner of indicating the slot format to the terminal device, because the SFI of each CC is separately indicated, relatively large signaling overheads are easily caused.

### SUMMARY

Embodiments of the present disclosure provide a slot format indication method, a device, and a system, to help reduce signaling overheads to some extent during slot format indication.

According to a first aspect, an embodiment of this application provides a slot format indication method, where the method includes: generating, by a network device, first indication information, and sending the first indication information to a terminal device, where the first indication information indicates K slot formats, the K slot formats are slot formats of M CCs configured for the terminal device, at least one slot format in the K slot formats is corresponding to at least two CCs in the M CCs, configuration parameters of the at least two CCs have at least one type of same parameter, K is an integer greater than or equal to 1 and less than or equal to M, M is an integer greater than 1, and the configuration parameter includes at least one of the following parameters: a subcarrier spacing, a cyclic prefix, a bandwidth, or a frequency band.

CCs whose configuration parameters have at least one type of same parameter may be indicated to the terminal device by using one slot format in the K slot formats indicated by the first indication information. Therefore, compared with a manner of separately indicating a slot format of each CC to the terminal device, it helps reduce signaling overheads to some extent during slot format indication.

It should be noted that, the M CCs in this embodiment of this application may be contiguous frequency domain resources, or may be non-contiguous frequency domain resources. This is not limited in this embodiment of this application.

For example, when a value of M is 4, four CCs configured for the terminal device are a CC 1, a CC 2, a CC 3, and a CC 4. It is assumed that a subcarrier spacing of the CC 1, a subcarrier spacing of the CC 2, and a subcarrier spacing of the CC 3 are all 15 KHz, and a subcarrier spacing of the CC 4 is 30 KHz. In this case, the first indication information in this embodiment of this application may indicate a slot format corresponding to the subcarrier spacing 15 KHz and a slot format corresponding to 30 KHz. The slot format corresponding to the subcarrier spacing 15 KHz is corresponding to the CC 1, the CC 2, and the CC 3, and the slot format corresponding to the subcarrier spacing 30 KHz is corresponding to the CC 4. Alternatively, the first indication information may indicate a slot format corresponding to the subcarrier spacing 15 KHz, a slot format corresponding to 15 KHz, and a slot format corresponding to 30 KHz. For example, one slot format corresponding to the subcarrier spacing 15 KHz is corresponding to the CC 1 and the CC 2, the other slot format corresponding to the subcarrier spacing 15 KHz is corresponding to the CC 3, and the slot format corresponding to the subcarrier spacing 30 KHz is corresponding to the CC 4.

In addition, for example, when a value of M is 2, two CCs configured for the terminal device are a CC 1 and a CC 2. It is assumed that a subcarrier spacing of the CC 1 is 15 KHz and a subcarrier spacing of the CC 2 is 30 KHz. In this case, the first indication information may indicate a slot format corresponding to the subcarrier spacing 15 KHz and a slot format corresponding to 30 KHz.

In an implementation, a design of the first indication information is as follows: The first indication information includes H fields, and each of K fields in the H fields indicates one slot format in the K slot formats, where H is a positive integer greater than or equal to K. The foregoing technical solution helps simplify an implementation of the first indication information.

To help the terminal device accurately read the first indication information, a design is as follows: After sending first configuration information to the terminal device, the network device sends the first indication information to the terminal device, where the first configuration information includes or indicates at least one of the following information:

a value of H, a parameter corresponding to each of the H fields, and one or more configurable slot formats.

In an implementation, another design of the first indication information is as follows: The first indication information indicates a first slot format combination manner, where the first slot format combination manner is a combination of slot formats corresponding to K types of parameters, and K is a type quantity of parameters corresponding to the M CCs. The foregoing technical solution helps reduce signaling overheads of the first indication information.

In an implementation, a design in which the network device sends the first indication information to the terminal device in this embodiment of this application is as follows: The network device sends the first indication information on N CCs in the M CCs, where N is an integer greater than or equal to 1, and N is less than or equal to M. When a value of N is 1, the foregoing technical solution helps reduce a quantity of times of blind detection performed by the terminal device, thereby reducing power consumption. When a value of N is greater than 1 and less than M, the foregoing technical solution helps reduce to some extent a quantity of times of blind detection performed by the terminal device, and improve reliability of transmitting the first indication information. When a value of N is M, the foregoing technical solution can improve reliability of transmitting the first indication information to a largest extent.

It should be noted that, generally, the network device sends the first indication information on group common PDCCHs on the N CCs.

A design in which the network device sends the first indication information on the N CCs in the M CCs is as follows: The network device sends the first indication information on each of the N CCs, that is, the network device sends one piece of complete first indication information on each of the N CCs. The foregoing technical solution helps improve reliability of transmitting the first indication information. Another design is as follows: The network device sends a part of the first indication information on each of the N CCs, where one piece of complete first indication information includes N parts of the first indication information. The foregoing technical solution helps reduce signaling overheads of the first indication information.

In addition, in this embodiment of this application, to enable the terminal device to determine a quantity of CCs on which the first indication information is transmitted and a specific CC on which the first indication information is transmitted, in a design, the network device sends second configuration information to the terminal device, where the second configuration information is used to configure N and the N CCs.

Another design is as follows: The value of N is predefined, and a specific CC used in the M CCs is determined by the network device, and then notified to the terminal device. In this case, the second configuration information may include only the N CCs. For example, when the value of M is 3, CCs configured for the terminal device are a CC 1, a CC 2, and a CC 3. It is assumed that the predefined value of N is 1. If the network device sends the first indication information to the terminal device by using the CC 1, the second configuration information includes the CC 1.

Particularly, when N=M, because all the M CCs can be used to send the first indication information, the second configuration information may not include the N CCs.

In a design, in slot formats of all CCs included in the M CCs, transmission directions at a same time domain location do not include both an uplink direction and a downlink direction. The foregoing technical solution helps avoid mutual interference between uplink and downlink, and further helps reduce signaling overheads of the first indication information.

According to a second aspect, an embodiment of this application provides a slot format indication method, where the method includes: receiving, by a terminal device, first indication information sent by a network device, and determining slot formats of M CCs based on the first indication information, where the first indication information indicates K slot formats, the K slot formats are the slot formats of the M CCs configured for the terminal device, at least one slot format in the K slot formats is corresponding to at least two CCs in the M CCs, configuration parameters of the at least two CCs have at least one type of same parameter, K is an integer greater than or equal to 1 and less than or equal to M, M is an integer greater than 1, and the configuration parameter includes at least one of the following parameters: a subcarrier spacing, a cyclic prefix, a bandwidth, or a frequency band.

CCs whose configuration parameters have at least one type of same parameter may be indicated to the terminal device by using one slot format in the K slot formats indicated by the first indication information. Therefore, compared with a manner of separately indicating a slot format of each CC to the terminal device, it helps reduce signaling overheads to some extent during slot format indication.

In an implementation, a design of the first indication information is as follows: The first indication information includes H fields, and each of K fields in the H fields indicates one slot format in the K slot formats, where H is a positive integer greater than or equal to K. The foregoing technical solution helps simplify an implementation of the first indication information.

To help the terminal device accurately read the first indication information, a design is as follows: After receiving first configuration information sent by the network device, the terminal device receives the first indication information sent by the network device, where the first configuration information includes or indicates at least one of the following information:

a value of H, a parameter corresponding to each of the H fields, and one or more configurable slot formats.

In an implementation, another design of the first indication information is as follows: The first indication information indicates a first slot format combination manner, where the first slot format combination manner is a combination of slot formats corresponding to K types of parameters, and K is a type quantity of parameters corresponding to the M CCs. The foregoing technical solution helps reduce signaling overheads of the first indication information.

In an implementation, a design in which the terminal device receives the first indication information sent by the network device in this embodiment of this application is as follows: The terminal device receives the first indication information sent by the network device on N CCs in the M CCs, where N is an integer greater than or equal to 1, and N is less than or equal to M. When a value of N is 1, the foregoing technical solution helps reduce a quantity of times of blind detection performed by the terminal device, thereby reducing power consumption. When a value of N is greater than 1 and less than M, the foregoing technical solution helps reduce to some extent a quantity of times of blind detection performed by the terminal device, and improve reliability of transmitting the first indication information. When a value of N is M, the foregoing technical solution can improve reliability of transmitting the first indication information to a largest extent.

A design in which the terminal device receives the first indication information sent by the network device on the N CCs in the M CCs is as follows: The terminal device receives the first indication information sent by the network device on each of the N CCs, that is, the network device sends one piece of complete first indication information on each of the N CCs. The foregoing technical solution helps improve reliability of transmitting the first indication information. Another design is as follows: The terminal device receives a part of the first indication information sent by the network device on each of the N CCs, where one piece of complete first indication information includes N parts of the first indication information. The foregoing technical solution helps reduce signaling overheads of the first indication information.

In addition, in this embodiment of this application, to enable the terminal device to determine a quantity of CCs on which the first indication information is transmitted and a specific CC on which the first indication information is transmitted, in a design, the terminal device receives second configuration information sent by the network device, where the second configuration information is used to configure N and the N CCs.

Another design is as follows: The value of N is predefined, and a specific CC used in the M CCs is determined by the network device, and then notified to the terminal device. In this case, the second configuration information may include only the N CCs. For example, when the value of M is 3, CCs configured for the terminal device are a CC 1, a CC 2, and a CC 3. It is assumed that the predefined value of N is 1. If the network device sends the first indication information to the terminal device by using the CC 1, the second configuration information includes the CC 1.

Particularly, when N=M, because all the M CCs can be used to send the first indication information, the second configuration information may not include the N CCs.

In a design, in slot formats of all CCs included in the M CCs, transmission directions at a same time domain location do not include both an uplink direction and a downlink direction. The foregoing technical solution helps avoid mutual interference between uplink and downlink, and further helps reduce signaling overheads of the first indication information.

According to a third aspect, an embodiment of this application provides a network device, including a processor, a memory, and a transceiver, where the memory is configured to store a program, the transceiver is configured to send and receive data, and the processor is configured to: invoke and execute the program stored in the memory, and send and receive data by using the transceiver, to implement the method in any one of the first aspect or the designs of the first aspect.

According to a fourth aspect, an embodiment of this application provides a terminal device, including a processor, a memory, and a transceiver, where the memory is configured to store a program, the transceiver is configured to send and receive data, and the processor is configured to: invoke and execute the program stored in the memory, and send and receive data by using the transceiver, to implement the method in any one of the second aspect or the designs of the second aspect.

According to a fifth aspect, an embodiment of this application provides a communications system, including the network device provided in the third aspect and the terminal device provided in the fourth aspect.

According to a sixth aspect, an embodiment of this application provides a chip, where the chip is connected to a memory, and is configured to read and execute a program stored in the memory, to implement the method in any one of the first aspect or the designs of the first aspect.

According to a seventh aspect, an embodiment of this application provides a chip, where the chip is connected to a memory, and is configured to read and execute a program stored in the memory, to implement the method in any one of the second aspect or the designs of the second aspect.

According to an eighth aspect, an embodiment of this application provides a computer storage medium, where the computer storage medium stores a program, and when the program is executed by a processor, the method in any one of the first aspect or the designs of the first aspect is implemented.

According to a ninth aspect, an embodiment of this application provides a computer storage medium, where the computer storage medium stores a program, and when the program is executed by a processor, the method in any one of the second aspect or the designs of the second aspect is implemented.

### BRIEF DESCRIPTION OF DRAWINGS

FIG. 1 is a schematic diagram of a slot format according to an embodiment of this application;

FIG. 2a and FIG. 2b are schematic architectural diagrams of a communications system applied to an embodiment of this application;

FIG. 3 is a schematic flowchart of a slot format indication method according to an embodiment of this application;

FIG. 4a and FIG. 4b are schematic structural diagrams of first indication information according to an embodiment of this application;

FIG. 5 is a schematic diagram of a slot format according to an embodiment of this application;

FIG. 6 is a schematic diagram of a slot format combination according to an embodiment of this application;

FIG. 7a and FIG. 7b are schematic structural diagrams of a network device according to an embodiment of this application;

FIG. 8a and FIG. 8b are schematic structural diagrams of a terminal device according to an embodiment of this application; and

FIG. 9 is a schematic structural diagram of a communications system according to an embodiment of this application.

### DESCRIPTION OF EMBODIMENTS

The following describes the embodiments of this application in detail with reference to the accompanying drawings in this specification.

In the embodiments of this application, CCs whose configuration parameters have at least one type of same parameter may be indicated to a terminal device by using one slot format in K slot formats indicated by first indication information. Therefore, compared with a manner of separately indicating a slot format of each CC, it helps reduce signaling overheads of slot format indication information to some extent.

It is understood that, a network device in the embodiments of this application may be a base station or an access point, or may be a device that is in an access network and communicates with a wireless terminal over an air interface by using one or more sectors. When the network device is a base station, the base station may be configured to mutually convert a received over-the-air frame and an Internet Protocol (IP) packet, and serve as a router between the wireless terminal and a remaining part of the access network, where the remaining part of the access network may include an IP network. The base station may be further configured to coordinate attribute management of the air interface. For example, the base station may be a base transceiver station (BTS) in a Global System for Mobile Communications (GSM) or a Code Division Multiple Access (CDMA) system, or may be a NodeB (nodeB) in a Wideband Code Division Multiple Access (WCDMA) system, or may be an evolved NodeB (evolutional nodeB, eNB) in a Long Term Evolution (LTE) system, or may be a 5th generation (5G) mobile communications technology node (gnodeB, gNB) in a next-generation wireless communications (NR) system. This is not limited in the embodiments of this application.

It is understood that, a terminal device in the embodiments of this application may be a device configured to provide voice and/or data connectivity for a user, a handheld device with a wireless connection function, or another processing device connected to a wireless modem. The terminal device in the embodiments of this application may also be a wireless terminal. The wireless terminal may communicate with one or more core networks by using a radio access network (RAN). The wireless terminal may be a mobile terminal, such as a mobile phone (also referred to as a “cellular” phone) or a computer with a mobile terminal. For example, the computer with a mobile terminal may be a portable, pocket-sized, handheld, computer built-in, or in-vehicle mobile apparatus which exchanges voice and/or data with the radio access network. For example, the wireless terminal may be a device such as a personal communication service (PCS) phone, a cordless phone, a Session Initiation Protocol (SIP) phone, a wireless local loop (WLL) station, or a personal digital assistant (PDA). The wireless terminal may also be referred to as a system, a subscriber unit (subscriber unit), a subscriber station, a mobile station, a mobile console (mobile), a remote station, an access point (AP), a remote terminal, an access terminal, a user terminal, a user agent, a user device, user equipment (UE), or the like. This is not limited in the embodiments of this application.

It is understood that a slot in the embodiments of this application is also referred to as a slot, and is a time domain unit of a resource used for transmitting data. One slot usually includes a plurality of symbols/chips, and the symbols/chips may have a same transmission direction or different transmission directions.

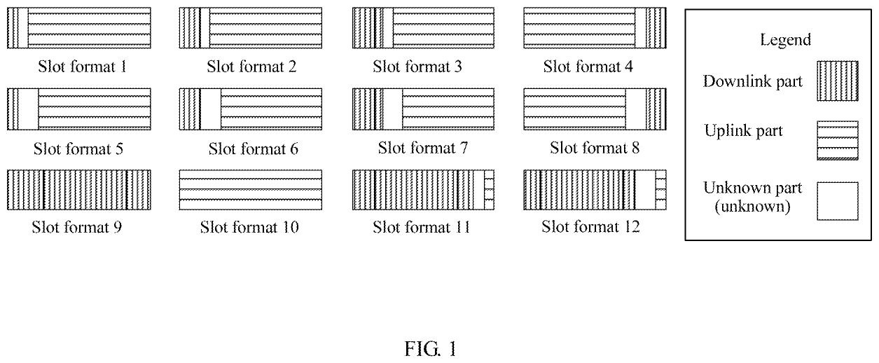

It is understood that the slot format in the embodiments of this application is also referred to as a slot format, and is used to indicate information such as a quantity of symbols/chips included in a slot, a symbol size, content carried on each symbol/chip in a slot, and a transmission direction on each symbol/chip. For example, assuming that one slot includes 14 symbols, possible slot formats may be shown in FIG. 1. The slot formats shown in FIG. 1 are only used as an example for description. In an actual communications system, only some or all of the slot formats shown in FIG. 1 may be used, or slot formats of other types different from the slot formats shown in FIG. 1 may be used. This is not limited in the embodiments of this application.

It is understood that the configuration parameter in the embodiments of this application may also be referred to as numerology, and includes at least one of the following parameters: a subcarrier spacing, a cyclic prefix (CP), a bandwidth, or a frequency band. It should be noted that the configuration parameter may further include another parameter such as a quantity of fast Fourier transformation (FFT) points. This is not limited in the embodiments of this application. The symbol size varies with the configuration parameter. The subcarrier spacing is used as an example. If the subcarrier spacing is 15 kilohertz (KHz), the symbol size is 1/15000 seconds (s). If the subcarrier spacing is 30 KHz, the symbol size is 1/30000s. In NR, generally, when the subcarrier spacing is less than or equal to 60 KHz, a quantity of symbols included in each slot is 7 or 14; or when the subcarrier spacing is greater than 60 KHz, a quantity of symbols included in each slot is 14.

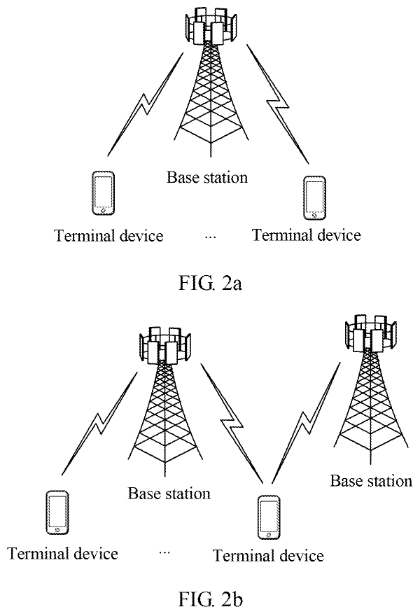

It is understood that the embodiments of this application may be applied to a communications system such as an NR system, an LTE system, an LTE-A system, or an enhanced Long Term Evolution (enhanced long term evolution-advanced, eLTE), and may be further applied to a related cellular system such as Wireless Fidelity (WiFi), Worldwide Interoperability for Microwave Access (WiMAX), or a 3rd Generation Partnership Project (3GPP). An architecture of a communications system applied to the embodiments of this application may be shown in FIG. 2a, where one terminal device is connected to one base station, and one base station manages a plurality of terminal devices. It should be noted that, a quantity of terminal devices in the communications system shown in FIG. 2a is not limited in the embodiments of this application. Alternatively, an architecture of a communications system applied to the embodiments of this application may be shown in FIG. 2b, where one terminal device is connected to a plurality of base stations, and one base station manages a plurality of terminal devices. It should be noted that, a quantity of base stations and a quantity of terminal devices in the communications system shown in FIG. 2b are not limited in the embodiments of this application.

That the network device is a base station is used as an example in the following to describe in detail a slot format indication method in the embodiments of this application. A slot format indication method used when the network device is another device is similar to the slot format indication method used when the network device is a base station. Details are not described herein.

As shown in FIG. 3, a slot format indication method in an embodiment of this application includes the following operations.

Operation 300. A base station generates first indication information, where the first indication information indicates K slot formats, the K slot formats are slot formats of M CCs configured for a terminal device, at least one slot format in the K slot formats is corresponding to at least two CCs in the M CCs, configuration parameters of the at least two CCs have at least one type of same parameter, K is an integer greater than or equal to 1, and M is an integer greater than or equal to 1 and less than or equal to K.

The configuration parameter includes at least one of the following parameters: a subcarrier spacing, a cyclic prefix, a bandwidth, or a frequency band.

Operation 301. The base station sends the first indication information to the terminal device.

Operation 302. After receiving the first indication information sent by the base station, the terminal device determines the slot formats of the M CCs based on the first indication information.

For example, the configuration parameter includes a subcarrier spacing and a cyclic prefix. It is assumed that in a configuration parameter of a CC 1, a subcarrier spacing is 15 KHz and a cyclic prefix is a normal cyclic prefix; and in a configuration parameter of a CC 2, a subcarrier spacing is 15 KHz and a cyclic prefix is an extended cyclic prefix. In this case, the subcarrier spacing in the configuration parameter of the CC 1 is the same as the subcarrier spacing in the configuration parameter of the CC 2. Therefore, the configuration parameters of the CC 1 and the CC have one type of same parameter. The configuration parameter includes a subcarrier spacing, a cyclic prefix, and a bandwidth. It is assumed that in a configuration parameter of a CC 1, a subcarrier spacing is 15 KHz, a cyclic prefix is a normal cyclic prefix, and a bandwidth is A; and in a configuration parameter of a CC 2, a subcarrier spacing is 15 KHz, a cyclic prefix is a normal cyclic prefix, and a bandwidth is B, where A is not equal to B. In this case, the subcarrier spacing in the configuration parameter of the CC 1 is the same as the subcarrier spacing in the configuration parameter of the CC 2, and the cyclic prefix in the configuration parameter of the CC 1 is the same as the cyclic prefix in the configuration parameter of the CC 2. Therefore, the configuration parameters of the CC 1 and the CC have two types of same parameters.

The following describes this embodiment of this application based on the following communications scenario.

It is assumed that a terminal device a, a terminal device b, a terminal device c, a terminal device d, and terminal device f are included in coverage of the base station. The base station configures three CCs for the terminal device a: a CC 1, a CC 2, and a CC 3. The base station configures two CCs for the terminal device b: a CC 4 and a CC 5. The base station configures four CCs for the terminal device c: a CC 6, a CC 7, a CC 8, and a CC 9. The base station configures one CC for the terminal device d: a CC 10. The base station configures two CCs for the terminal device f: a CC 11 and a CC 12. The CC 1 to the CC 12 may be contiguous frequency domain resources, or may be non-contiguous frequency domain resources. This is not limited in this embodiment of this application.

Case 1: The base station separately sends the first indication information to different terminal devices. The base station may divide, into one group, CCs that are configured for a same terminal device. The terminal device c is used as an example. It is assumed that the configuration parameter is a subcarrier spacing. If a subcarrier spacing of the CC 6, a subcarrier spacing of the CC 7, and a subcarrier spacing of the CC 8 are 15 KHz, and a subcarrier spacing of the CC 9 is 30 KHz, the first indication information may indicate one slot format corresponding to 15 KHz and one slot format corresponding to 30 KHz. The slot format corresponding to 15 KHz is used to indicate slot formats of the CC 6, the CC 7, and the CC 8, and the slot format corresponding to 30 KHz is used to indicate a slot format of the CC 9. Alternatively, the first indication information may indicate two slot formats corresponding to 15 KHz and one slot format corresponding to 30 KHz. One slot format corresponding to 15 KHz may be used to indicate slot formats of two of the CC 6, the CC 7, and the CC 8, and the other slot format corresponding to 15 KHz is used to indicate a slot format of the remaining one of the CC 6, the CC 7, and the CC 8. If a subcarrier spacing of the CC 6 is 15 KHz, a subcarrier spacing of the CC 7 is 30 KHz, a subcarrier spacing of the CC 8 is 60 KHz, and a subcarrier spacing of the CC 9 is 120 KHz, the first indication information indicates a slot format corresponding to 15 KHz, a slot format corresponding to 30 KHz, a slot format corresponding to 60 KHz, and a slot format corresponding to 120 KHz.

Case 2: The base station may alternatively divide, into one or more groups, CCs that are in the CCs configured for the terminal device a, the terminal device b, the terminal device c, and the terminal device d and whose configuration parameters have at least one type of same configuration parameter. A specific quantity of groups obtained through division is determined by the base station. Generally, the quantity of groups obtained through division is not greater than a total quantity of the CCs whose configuration parameters have at least one type of same configuration parameter. It is assumed that the configuration parameter includes a subcarrier spacing and a cyclic prefix. If a subcarrier spacing of the CC 1, a subcarrier spacing of the CC 4, and a subcarrier spacing of the CC 6 are all 15 KHz, the first indication information indicates a slot format corresponding to 15 KHz.

In addition, the base station may divide, in another manner, the CCs configured for the terminal device a, the terminal device b, the terminal device c, and the terminal device d, and details are not described herein. When division is performed in another manner, it is assumed that the CC 1, the CC 3, the CC 4, and the CC 7 belong to one group. A subcarrier spacing of the CC 1 is 15 KHz, a subcarrier spacing of the CC 3 is 60 KHz, and both a subcarrier spacing of the CC 4 and a subcarrier spacing of the CC 7 are 60 KHz. In this case, slot format indication information of the group of CCs is used to indicate a slot format corresponding to 15 KHz, a slot format corresponding to 30 KHz, and a slot format corresponding to 60 KHz. In an implementation, the first indication information is the slot format indication information of the group of CCs. In another implementation, because the base station configures only the CC 1 for the terminal device a, the slot format corresponding to 60 KHz and the slot format corresponding to 30 KHz are redundant information for the terminal device a, and the base station needs to send, to the terminal device a, only the first indication information in the slot format indication information corresponding to the group of CCs, where the first indication information indicates the slot format corresponding to 15 KHz.

It should be further noted that, in this embodiment of this application, division performed by the base station on the CCs may be UE common, that is, division performed by the base station on the CCs is the same for all terminal devices in the coverage of the base station. For example, if the base station divides the CC 1 and the CC 2 into one group, the CC 1 and the CC 2 belong to one group for the terminal device a, and the CC 1 and the CC 2 also belong to one group for the terminal device b. In this embodiment of this application, division performed by the base station on the CCs may be UE specific, that is, if the CC 1 and the CC 2 belong to one group for the terminal device a, the CC 1 and the CC 2 may belong to different CC groups for the terminal device b.

The base station may notify the terminal devices of division information of the CCs (for example, how the base station divides the CCs) by using radio resource control (RRC) signaling or Media Access Control (MAC) signaling.

In this embodiment of this application, an implementation in which the first indication information indicates K slot formats is as follows:

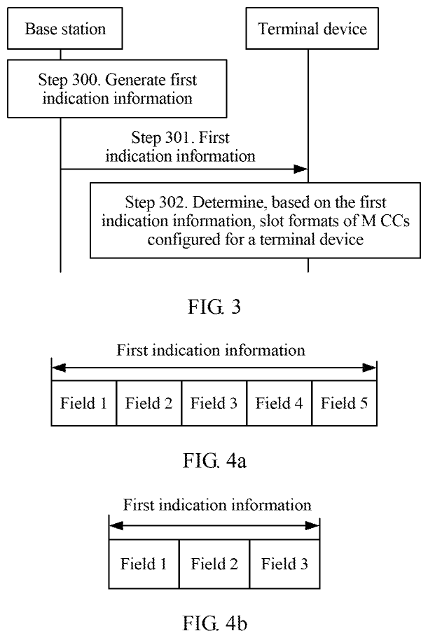

The first indication information includes H fields, and each of K fields in the H fields indicates one slot format in the K slot formats, where H is a positive integer greater than or equal to K. For example, it is assumed that the first indication information indicates three slot formats: a slot format 1, a slot format 2, and a slot format 3. A subcarrier spacing 15 KHz is corresponding to the slot format 1, a subcarrier spacing 30 KHz is corresponding to the slot format 2, and a subcarrier spacing 60 KHz is corresponding to the slot format 3. If H is a total type quantity of subcarrier spacings, for example, the total type quantity of subcarrier spacings is 5, and specific subcarrier spacings may be 15 KHz, 30 KHz, 60 KHz, 120 KHz, and 240 KHz, a value of H may be 5. As shown in FIG. 4a, a field 1 is corresponding to 15 KHz, a field 2 is corresponding to 30 KHz, a field 3 is corresponding to 60 KHz, a field 4 is corresponding to 120 KHz, and a field 5 is corresponding to 240 KHz. In this case, the field 1 is used to indicate the slot format 1, the field 2 is used to indicate the slot format 2, the field 3 is used to indicate the slot format 3, and the field 4 and the field 5 are empty, or the field 4 indicates a slot format corresponding to the subcarrier spacing 120 KHz, and the field 5 indicates a slot format corresponding to the subcarrier spacing 240 KHz. Alternatively, H may be a total type quantity of parameters of the K slot formats. It is assumed that the first indication information indicates three slot formats: a slot format 1, a slot format 2, and a slot format 3. A subcarrier spacing 15 KHz is corresponding to the slot format 1, a subcarrier spacing 30 KHz is corresponding to the slot format 2, and a subcarrier spacing 60 KHz is corresponding to the slot format 3. As shown in FIG. 4b, a field 1 is corresponding to 15 KHz, a field 2 is corresponding to 30 KHz, and a field 3 is corresponding to 60 KHz. In this case, the field 1 is used to indicate the slot format 1, the field 2 is used to indicate the slot format 2, and the field 3 is used to indicate the slot format 3.

In this embodiment of this application, the value of H, a parameter corresponding to each of the H fields, and one or more configurable slot formats may be preconfigured by the base station for the terminal device, or may be predefined. The base station sends first configuration information to the terminal device, and the first configuration information includes or indicates at least one of the following information: the value of H, the parameter corresponding to each of the H field, or the one or more configurable slot formats.

For example, if the value of H is predefined, the base station does not need to notify the terminal device by using the first configuration information.

Notifying the terminal device of the one or more configurable slot formats helps reduce signaling overheads. For example, it is assumed that a total type quantity of slot formats is W. The subcarrier spacing is used as an example. If only A types of slot formats in the W types of slot formats can be configured when the subcarrier spacing is 15 KHz, where A is less than W, when the base station does not notify the terminal device of the one or more configurable slot formats, or the one or more configurable slot formats are predefined, a length of 15 KHz in a corresponding field is ┌log W┐; or when the base station notifies the terminal device of the one or more configurable slot formats, or the one or more configurable slot formats are predefined, a length of 15 KHz in a corresponding field is ┌log A┐. Because A is less than W, signaling overheads of the first indication information are reduced.

In addition, this embodiment of this application further provides an implementation of the first indication information:

The first indication information indicates a first slot format combination manner, where the first slot combination manner is a combination of slot formats corresponding to K types of parameters, and K is a type quantity of parameters corresponding to the M CCs.

For example, the parameter is a subcarrier spacing. If a total type quantity of subcarriers corresponding to the M CCs is 2, the subcarrier spacings are a subcarrier spacing 15 KHz and a subcarrier spacing 30 KHz. If possible combination manners of slot formats corresponding to 15 KHz and 30 KHz are: {slot format 1, slot format 2}, {slot format 2, slot format 3}, and {slot format 4, slot format 5}, and in the M CCs, a slot format of a CC with 15 KHz is the slot format 4 and a slot format of a CC with 30 KHz is the slot format 5, the first indication information indicates a first slot format combination manner {slot format 4, slot format 5}. In this embodiment of this application, the three combination manners are separately encoded. For example, 00 indicates the slot format combination manner {slot format 1, slot format 2}, 01 indicates the slot format combination manner {slot format 2, slot format 3}, and 11 indicates the slot format combination manner {slot format 4, slot format 5}. In this case, the first indication information is 11. This technical solution helps further reduce signaling overheads of the first indication information. The slot format combination manner and an encoding manner, such as 00 and 01, of the slot format combination manner may be notified to the terminal device by using RRC signaling or MAC signaling.

It should be noted that in the foregoing two implementations of the first indication information, a size of a slot varies with a subcarrier spacing. For example, a slot corresponding to a subcarrier spacing 15 KHz is twice a slot corresponding to a subcarrier spacing 30 KHz. In this case, if the first indication information indicates a slot format 1 and a slot format 2, where the slot format 1 is a slot format corresponding to the subcarrier spacing 15 KHz and the slot format 2 is a slot format corresponding to the subcarrier spacing 30 KHz, assuming that a subcarrier spacing of a CC 1 is 15 KHz and a subcarrier spacing of a CC 2 is 30 KHz, a slot format of the CC 1 in the slot corresponding to 15 KHz is the slot format 1, the CC 2 includes two slots corresponding to 30 KHz in a time period of the slot corresponding to 15 KHz, and therefore a slot format of the CC 2 in each of the two slots corresponding to 30 KHz is the slot format 2.

In this embodiment of this application, to avoid mutual interference between uplink and downlink, in slot formats of all CCs included in the M CCs, transmission directions at a same time domain location do not include both an uplink direction and a downlink direction.

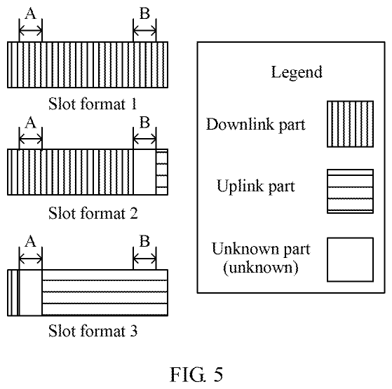

Slot formats shown in FIG. 5 are used as an example. A slot format 1 has a downlink transmission direction at a time domain location A, a slot format 2 has a downlink transmission direction at the time domain location A, and a slot format 3 has an unknown transmission direction at the time domain location A. In this case, for the slot format 1, the slot format 2, and the slot format 3, the transmission directions at the time domain location A do not include both an uplink direction and a downlink direction. The slot format 1 has a downlink transmission direction at a time domain location B, the slot format 2 has an unknown transmission direction at the time domain location B, and the slot format 3 has an uplink transmission direction at the time domain location B. In this case, the transmission direction at the time domain location B in the slot format 1 and the transmission direction at the time domain location B in the slot format 3 include both an uplink direction and a downlink direction. Therefore, the slot formats included in the M CCs do not include both the slot format 1 and the slot format 3. The slot format 2 at the time domain location B and the slot format 1 at the time domain location B do not include both an uplink direction and a downlink direction, and the slot format 2 at the time domain location B and the slot format 3 at the time domain location B do not include both an uplink direction and a downlink direction.

In addition, when in the slot formats of all the CCs included in the M CCs, transmission directions at a same time domain location do not include both an uplink direction and a downlink direction, this embodiment of this application further provides an implementation of the first indication information.

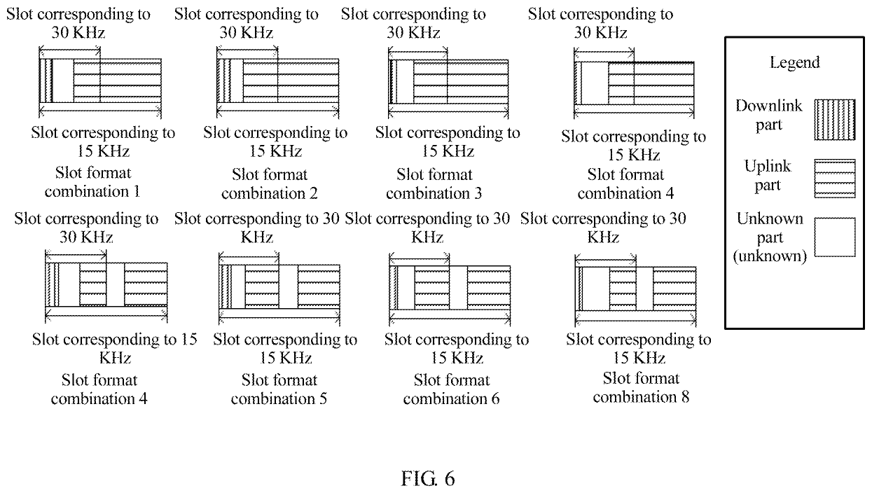

It is assumed that all possible slot formats corresponding to a subcarrier spacing 15 KHz are shown in FIG. 1. If M is 2, the M CCs are specifically a CC 1 and a CC 2. It is assumed that a subcarrier spacing of the CC 1 is 15 KHz and a subcarrier spacing of the CC 2 is 30 KHz. If a slot format of the CC 1 is a slot format 6 shown in FIG. 1, possible combinations shown in FIG. 6 exist when in slot formats of the CC 2 in the first slot corresponding to 30 KHz and the second slot corresponding to 30 KHz in a slot corresponding to 15 KHz, transmission directions at a same time domain location do not include both an uplink direction and a downlink direction. When the slot formats of the CC 2 in the first slot corresponding to 30 KHz and the second slot corresponding to 30 KHz are a combination (5) shown in FIG. 6, the combination (5) and the slot format 6 may be combined and encoded, and notified to the terminal device; or the slot formats of the CC 1 and the CC 2 may be notified to the terminal device by using two fields. One field indicates the slot format 6, and the other field indicates a combination manner of the slot formats of the CC 2 in the first slot corresponding to 30 KHz and the second slot corresponding to 30 KHz. In addition, in this embodiment of this application, a slot format of a CC configured for the terminal device may be further indicated to the terminal device in another manner. This is not limited in this embodiment of this application.

In this embodiment of this application, that the base station sends the first indication information to the terminal device may be implemented in the following manner:

The base station sends the first indication information on N CCs in the M CCs, where N is an integer greater than or equal to 1, and N is less than or equal to M.

For example, when N=1, the base station may send the first indication information to the terminal device on one CC in the M CCs. The base station sends the first indication information on a group common PDCCH on the CC. It should be further noted that the CC in the M CCs may be predefined; or N=1 may be predefined, and then the base station notifies the terminal device of a specific CC, in the M CCs, on which the first indication information is sent; or the base station may notify the terminal device of a value of N and a specific CC on which the first indication information is sent. For example, the base station sends second configuration information to the terminal device, and the second configuration information includes a CC selected from the M CCs and a quantity of CCs on which the first indication information is sent. Because the first indication information is sent only on one CC in this technical solution, it helps reduce a quantity of times of blind detection performed by the terminal device.

For example, a value of N may be greater than 1 and less than M, and the base station sends the first indication information on each of the N CCs. Compared with a manner of sending the first indication information on each of the M CCs, in this manner, a quantity of times of blind detection is reduced to some extent, and it helps improve reliability of receiving the first indication information by the terminal device. In this case, to enable the terminal device to determine CCs on which the base station sends the first indication information, a specific implementation thereof is similar to that existing when the value of N is 1, and details are not described herein again.

For example, a value of N may be M, and the base station sends the first indication information on each of the M CCs. In this case, a quantity of CCs on which the first indication information is sent and the M CCs may be notified to the terminal device in a predefining or notification manner. In this manner, reliability of receiving the first indication information by the terminal device is improved to a largest extent. When N=M, a specific implementation in which the terminal device determines specific CCs on which the base station sends the first indication information may be similar to that existing when the value of N is 1. In addition, when N=M is predefined, the second configuration information may not include the M CCs. A reason is that after determining that N=M, the terminal device may determine to receive the first indication information on all the CCs, and no additional indication needs to be provided.

In addition, in this embodiment of this application, when the value of N is greater than 1, a part of the first indication information may be sent on some of the N CCs, and one piece of complete first indication information includes N parts of the first indication information. The base station sends a part of the first indication information on each of the N CCs, and the first indication information includes N parts of the first indication information. For example, it is assumed that the value of N is 2, and the N CCs are a CC 1 and a CC 2. The first indication information is divided into two parts. One part is sent to the terminal device on the CC 1, and the other part is sent to the terminal device on the CC 2. In this case, CCs on which the base station sends the first indication information and a quantity of the CCs on which the base station sends the first indication information may be sent to the terminal device by using the second configuration information.

Based on a same concept, an embodiment of this application further provides a network device, configured to perform an action or a function of the network device in the foregoing method embodiment.

Based on a same concept, an embodiment of this application further provides a terminal device, configured to perform an action or a function of the terminal device in the foregoing method embodiment.

An embodiment of the present disclosure further provides a communications system, including the network device and the terminal device in the foregoing embodiment.

For brevity, for an implementation of content of the apparatus part, refer to the method embodiment, and details are not described again.

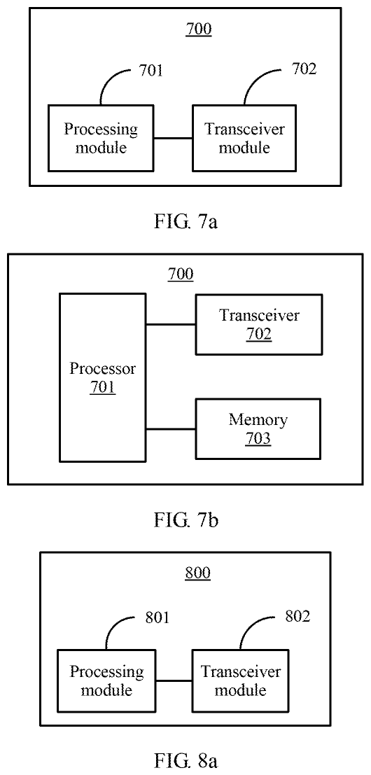

As shown in FIG. 7a, a network device 700 in an embodiment of this application includes a processing module 701 and a transceiver module 702. The processing module 701 is configured to generate first indication information. The transceiver module is configured to send the first indication information to a terminal device. The first indication information indicates K slot formats. The K slot formats are slot formats of M CCs configured for the terminal device. At least one slot format in the K slot formats is corresponding to at least two CCs in the M CCs. Configuration parameters of the at least two CCs have at least one type of same parameter. K is an integer greater than or equal to 1 and less than or equal to M, and M is an integer greater than 1. The configuration parameter includes at least one of the following parameters: a subcarrier spacing, a cyclic prefix, a bandwidth, or a frequency band.

In an implementation, a design of the first indication information is as follows: The first indication information includes H fields, and each of K fields in the H fields indicates one slot format in the K slot formats, where H is a positive integer greater than or equal to K.

To help the terminal device accurately read the first indication information, a design is as follows: The transceiver module 702 is configured to: after sending first configuration information to the terminal device, send the first indication information to the terminal device, where the first configuration information includes or indicates at least one of the following information:

a value of H, a parameter corresponding to each of the H fields, and one or more configurable slot formats.

In an implementation, another design of the first indication information is as follows: The first indication information indicates a first slot format combination manner, where the first slot format combination manner is a combination of slot formats corresponding to K types of parameters, and K is a type quantity of parameters corresponding to the M CCs.

In an implementation, a design in which the transceiver module 702 is configured to send the first indication information to the terminal device in this embodiment of this application is as follows: The transceiver module 702 is configured to send the first indication information on N CCs in the M CCs, where N is an integer greater than or equal to 1, and N is less than or equal to M. When a value of N is 1, the foregoing technical solution helps reduce a quantity of times of blind detection performed by the terminal device, thereby reducing power consumption. When a value of N is greater than 1 and less than M, the foregoing technical solution helps reduce to some extent a quantity of times of blind detection performed by the terminal device, and improve reliability of transmitting the first indication information. When a value of N is M, the foregoing technical solution can improve reliability of transmitting the first indication information to a largest extent.

It should be noted that, generally, the transceiver module 702 sends the first indication information on group common PDCCHs on the N CCs.

A design in which the transceiver module 702 is configured to send the first indication information on the N CCs in the M CCs is as follows: The transceiver module 702 is configured to send the first indication information on each of the N CCs, that is, send one piece of complete first indication information on each of the N CCs. Another design is as follows: The transceiver module 702 is configured to send a part of the first indication information on each of the N CCs, where one piece of complete first indication information includes N parts of the first indication information.

In addition, in this embodiment of this application, to enable the terminal device to determine a quantity of CCs on which the first indication information is transmitted and a specific CC on which the first indication information is transmitted, in a design, the transceiver module 702 is configured to send second configuration information to the terminal device, where the second configuration information is used to configure N and the N CCs.

In a design, in slot formats of all CCs included in the M CCs, transmission directions at a same time domain location do not include both an uplink direction and a downlink direction. The foregoing technical solution helps avoid mutual interference between uplink and downlink, and further helps reduce signaling overheads of the first indication information.

FIG. 7b is a schematic diagram of a hardware structure of the network device 700 shown in FIG. 7a, including a processor 710, a transceiver 720, and a memory 730. A hardware entity corresponding to the processing module 701 in the network device 700 is the processor 710, and a hardware entity corresponding to the transceiver module 702 is the transceiver 720. The transceiver 720 includes a receiver and a transmitter. The memory 730 may be configured to store a program/code pre-installed when the terminal device is at delivery, or may be configured to store code or the like executed by the processor 710.

The processor 710 may be a general purpose central processing unit (CPU), a microprocessor, an application-specific integrated circuit (ASIC), or one or more integrated circuits, and is configured to perform a related operation, to implement the technical solutions provided in the embodiments of this application.

It should be noted that, although only the processor 710, the transceiver 720, and the memory 730 are shown in the network device 700 shown in FIG. 7b, in a specific implementation process, persons skilled in the art should understand that the network device 700 further includes another component required for implementing normal running. In addition, persons skilled in the art should understand that, based on a specific requirement, the network device 700 may further include a hardware component for implementing another additional function. In addition, persons skilled in the art should understand that the network device 700 may include only components or modules required for implementing this embodiment of this application, but not necessarily include all the components shown in FIG. 7b.

Persons of ordinary skill in the art may understand that all or some of the processes of the methods in the embodiments may be implemented by a computer program instructing relevant hardware. The program may be stored in a computer readable storage medium. When the program is executed, the processes of the methods in the embodiments are performed. The foregoing storage medium may be a magnetic disk, an optical disc, a read-only memory (ROM), a random access memory (RAM), or the like.

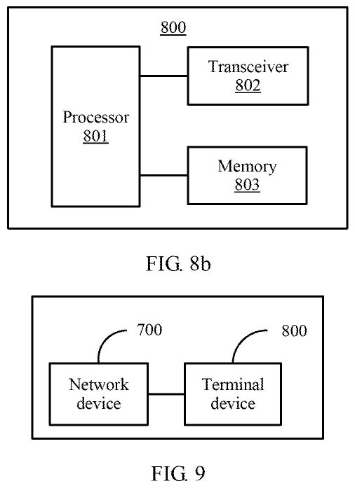

As shown in FIG. 8a, a terminal device 800 in an embodiment of this application includes a processing module 801 and a transceiver module 802. The transceiver module 802 is configured to receive first indication information sent by a network device. The processing module 801 is configured to determine slot formats of M CCs based on the first indication information. The first indication information indicates K slot formats. The K slot formats are the slot formats of the M CCs configured for the terminal device. At least one slot format in the K slot formats is corresponding to at least two CCs in the M CCs. Configuration parameters of the at least two CCs have at least one type of same parameter. K is an integer greater than or equal to 1 and less than or equal to M, and M is an integer greater than 1. The configuration parameter includes at least one of the following parameters: a subcarrier spacing, a cyclic prefix, a bandwidth, or a frequency band.

In an implementation, a design of the first indication information is as follows: The first indication information includes H fields, and each of K fields in the H fields indicates one slot format in the K slot formats, where H is a positive integer greater than or equal to K.

To help the terminal device accurately read the first indication information, a design is as follows: The transceiver module 802 is configured to: after receiving first configuration information sent by the network device, receive the first indication information sent by the network device, where the first configuration information includes or indicates at least one of the following information:

a value of H, a parameter corresponding to each of the H fields, and one or more configurable slot formats.

In an implementation, another design of the first indication information is as follows: The first indication information indicates a first slot format combination manner, where the first slot format combination manner is a combination of slot formats corresponding to K types of parameters, and K is a type quantity of parameters corresponding to the M CCs.

In an implementation, a design in which the transceiver module 802 is configured to receive the first indication information sent by the network device in this embodiment of this application is as follows: The transceiver module 802 is configured to receive the first indication information sent by the network device on N CCs in the M CCs, where N is an integer greater than or equal to 1, and N is less than or equal to M. When a value of N is 1, the foregoing technical solution helps reduce a quantity of times of blind detection performed by the terminal device, thereby reducing power consumption. When a value of N is greater than 1 and less than M, the foregoing technical solution helps reduce to some extent a quantity of times of blind detection performed by the terminal device, and improve reliability of transmitting the first indication information. When a value of N is M, the foregoing technical solution can improve reliability of transmitting the first indication information to a largest extent.

A design in which the transceiver module 802 is configured to receive the first indication information sent by the network device on the N CCs in the M CCs is as follows: The transceiver module 802 is configured to receive the first indication information sent by the network device on each of the N CCs, that is, the network device sends one piece of complete first indication information on each of the N CCs. Another design is as follows: The transceiver module 802 is configured to receive a part of the first indication information sent by the network device on each of the N CCs, where one piece of complete first indication information includes N parts of the first indication information.

In addition, in this embodiment of this application, to enable the terminal device to determine a quantity of CCs on which the first indication information is transmitted and a specific CC on which the first indication information is transmitted, in a design, the transceiver module 802 is further configured to receive second configuration information sent by the network device, where the second configuration information is used to configure N and the N CCs.

In a design, in slot formats of all CCs included in the M CCs, transmission directions at a same time domain location do not include both an uplink direction and a downlink direction. The foregoing technical solution helps avoid mutual interference between uplink and downlink, and further helps reduce signaling overheads of the first indication information.

FIG. 8b is a schematic diagram of a hardware structure of the terminal device 800 shown in FIG. 8a, including a processor 810, a transceiver 820, and a memory 830. A hardware entity corresponding to the processing module 801 in the terminal device 800 is the processor 810, and a hardware entity corresponding to the transceiver module 802 is the transceiver 820. The transceiver 820 includes a receiver and a transmitter. The memory 830 may be configured to store a program/code pre-installed when the terminal device is at delivery, or may be configured to store code or the like executed by the processor 810.

The processor 810 may be a general purpose CPU, a microprocessor, an ASIC, or one or more integrated circuits, and is configured to perform a related operation, to implement the technical solutions provided in the embodiments of this application.

It should be noted that, although only the processor 810, the transceiver 820, and the memory 830 are shown in the terminal device 800 shown in FIG. 8b, in an implementation process, persons skilled in the art understand that the terminal device 800 further includes another component required for implementing normal running. In addition, persons skilled in the art also understand that, based on a specific requirement, the terminal device 800 may further include a hardware component for implementing another additional function. In addition, persons skilled in the art understands that the terminal device 800 may include only components or modules required for implementing this embodiment of this application, but not necessarily include all the components shown in FIG. 8b.

Persons of ordinary skill in the art may understand that all or some of the processes of the methods in the embodiments may be implemented by a computer program instructing relevant hardware. The program may be stored in a computer readable storage medium. When the program is executed, the processes of the methods in the embodiments are performed. The foregoing storage medium may be a magnetic disk, an optical disc, a ROM, a RAM, or the like.

As shown in FIG. 9, a communications system in an embodiment of this application includes the network device 700 and the terminal device 800.

Persons skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a CD-ROM, and an optical memory) that include computer usable program code.

This application is described with reference to the flowcharts and/or block diagrams of the method, the device (system), and the computer program product according to the embodiments of this application. It is understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and operations are performed on the computer or the another programmable device, thereby generating computer-implemented processing. Therefore, the instructions executed on the computer or the another programmable device provide operations for implementing a specific function in one or more processes in the flowcharts and/or in one or more blocks in the block diagrams.

Although some embodiments of this application have been described, persons skilled in the art can make changes and modifications to these embodiments once they learn the basic inventive concept. Therefore, the following claims are intended to be construed as to cover the embodiments of this application and all changes and modifications falling within the scope of this application.

Persons skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A slot format indication method, wherein the method comprises:
generating, by a network device, first indication information; and
sending, by the network device, the first indication information to a terminal device, wherein the first indication information indicates K slot formats, the K slot formats are slot formats of M component carriers configured for the terminal device, at least one slot format in the K slot formats corresponds to at least two CCs in the M CCs, configuration parameters of the at least two CCs have at least one type of same parameter, K is an integer greater than or equal to 1 and less than or equal to M, and M is an integer greater than 1, wherein
the configuration parameters comprise at least one of the following parameters: a subcarrier spacing, a cyclic prefix, a bandwidth, or a frequency band.

2. The method according to claim 1, wherein that the first indication information indicates K slot formats comprises:
the first indication information comprises H fields, and each of K fields in the H fields indicates one slot format in the K slot formats, wherein H is a positive integer greater than or equal to K.

3. The method according to claim 2, before the sending, by the network device, the first indication information to the terminal device, further comprising:
sending, by the network device, first configuration information to the terminal device, wherein the first configuration information comprises or indicates at least one of the following information: a value of H, a parameter corresponding to each of the H fields, and one or more configurable slot formats.

4. The method according to claim 1, wherein that the first indication information indicates K slot formats comprises:
the first indication information indicates a first slot format combination manner, wherein the first slot format combination manner is a combination of slot formats corresponding to K types of parameters, and K is a type quantity of parameters corresponding to the M CCs.

5. The method according to claim 1, wherein the sending, by the network device, first indication information to the terminal device comprises:
sending, by the network device, the first indication information on N CCs in the M CCs, wherein N is an integer greater than or equal to 1, and N is less than or equal to M.

6. The method according to claim 5, wherein the sending, by the network device, the first indication information on N CCs in the M CCs comprises:
sending, by the network device, the first indication information on each of the N CCs; or
sending, by the network device, a part of the first indication information on each of the N CCs, wherein the first indication information consists of N parts of the first indication information.

7. The method according to claim 5, wherein the method further comprises:
sending, by the network device, second configuration information to the terminal device, wherein the second configuration information is used to configure N and the N CCs.

8. The method according to claim 1, wherein in slot formats of all CCs comprised in the M CCs, transmission directions at a same time domain location do not comprise both an uplink direction and a downlink direction.

9. A slot format indication method, wherein the method comprises:
receiving, by a terminal device, first indication information sent by a network device, wherein the first indication information indicates K slot formats, the K slot formats are slot formats of M component carriers (CCs) configured for the terminal device, at least one slot format in the K slot formats corresponds to at least two CCs in the M CCs, configuration parameters of the at least two CCs have at least one type of same parameter, K is an integer greater than or equal to 1 and less than or equal to M, M is an integer greater than 1, and the configuration parameter comprises at least one of the following parameters: a subcarrier spacing, a cyclic prefix, a bandwidth, or a frequency band; and
determining, by the terminal device, the slot formats of the M CCs based on the first indication information.

10. The method according to claim 9, wherein that the first indication information indicates K slot formats comprises:
the first indication information comprises H fields, and each of K fields in the H fields indicates one slot format in the K slot formats, wherein H is a positive integer greater than or equal to K.

11. The method according to claim 10, before the receiving, by the terminal device, first indication information sent by the network device, further comprising:
receiving, by the terminal device, first configuration information sent by the network device, wherein the first configuration information comprises or indicates at least one of the following information: a value of H, a parameter corresponding to each of the H fields, and one or more configurable slot formats.

12. The method according to claim 9, wherein that the first indication information indicates K slot formats comprises:
the first indication information indicates a first slot format combination manner, wherein the first slot format combination manner is a combination of slot formats corresponding to K types of parameters, and K is a type quantity of parameters corresponding to the M CCs.

13. The method according to claim 9, wherein the receiving, by the terminal device, first indication information sent by the network device comprises:
receiving, by the terminal device, the first indication information sent by the network device on N CCs in the M CCs, wherein N is an integer greater than or equal to 1, and N is less than or equal to M.

14. The method according to claim 13, wherein the receiving, by the terminal device, the first indication information sent by the network device on N CCs in the M CCs comprises:
receiving, by the terminal device, the first indication information sent by the network device on each of the N CCs; or
receiving, by the terminal device, a part of the first indication information sent by the network device on each of the N CCs, wherein the first indication information consists of N parts of the first indication information.

15. The method according to claim 13, wherein the method further comprises:
receiving, by the terminal device, second configuration information sent by the network device, wherein the second configuration information is used to configure N and the N CCs.

16. The method according to claim 9, wherein in slot formats of all CCs comprised in the M CCs, transmission directions at a same time domain location do not comprise both an uplink direction and a downlink direction.

17. (canceled)

18. A terminal device, comprising a processor, a memory, and a transceiver, wherein
the memory is configured to store a program;
the transceiver is configured to send and receive data; and
the processor is configured to: invoke and execute the program stored in the memory, and send and receive data by using the transceiver, to implement operations comprising:
receiving first indication information sent by a network device, wherein the first indication information indicates K slot formats, the K slot formats are slot formats of M component carriers CCs configured for the terminal device, at least one slot format in the K slot formats is corresponding to at least two CCs in the M CCs, configuration parameters of the at least two CCs have at least one type of same parameter, K is an integer greater than or equal to 1 and less than or equal to M, M is an integer greater than 1, and the configuration parameter comprises at least one of the following parameters: a subcarrier spacing, a cyclic prefix, a bandwidth, or a frequency band; and
determining the slot formats of the M CCs based on the first indication information.

19-23. (canceled)

24. The terminal device according to claim 18, wherein that the first indication information indicates K slot formats comprises:
the first indication information comprises H fields, and each of K fields in the H fields indicates one slot format in the K slot formats, wherein H is a positive integer greater than or equal to K.

25. The terminal device according to claim 18, wherein that the first indication information indicates K slot formats comprises:
the first indication information indicates a first slot format combination manner, wherein the first slot format combination manner is a combination of slot formats corresponding to K types of parameters, and K is a type quantity of parameters corresponding to the M CCs.

26. The terminal device according to claim 18, wherein the receiving first indication information sent by the network device comprises:
receiving, by the terminal device, the first indication information sent by the network device on N CCs in the M CCs, wherein N is an integer greater than or equal to 1, and N is less than or equal to M.
